(19) United States
(12) Patent Application Publication
(10) Pub. No.: US 2011/0100890 A1
(43) Pub. Date: May 5, 2011

(54) PROCESS FOR RE-MINERALIZING WATER DEFICIENT IN MAGNESIUM

(76) Inventor: Mark Brotman, Burton, OH (US)

(21) Appl. No.: 12/990,230

(22) PCT Filed: May 1, 2009
(86) PCT No.: PCT/US09/42501

§ 371 Date: Dec. 8, 2010

Related U.S. Application Data
(62) Division of application No. 61/126,319, filed on May 2, 2008.

(51) Int. Cl. B01D 61/10

(52) U.S. Cl. 210/202

(57) ABSTRACT

The present invention relates to the process of re-mineralizing treated potable water that has had hardness components removed by dissolving a magnesium compound in the treated water. The resulting concentration of magnesium, pH level and alkalinity level are controlled by the inclusion of a calcium compound such as calcium carbonate and a bypass orifice. The bypass orifice allows a portion of pretreated wafer to bypass a filter that contains the magnesium compound. The process is particularly useful as an in-line process for continuous or semi-continuous treatment of water. The preferred magnesium and calcium compounds include magnesium phosphate dibasic trihydrate and calcium carbonate, respectively.

### TECHNICAL FIELD

The present invention relates generally to fluid treatment systems and in particular to a method and apparatus for producing water that contains desired minerals for taste and is better health wise tot human consumption. The process is particularly useful as an in-line process for continuous or semi-continuous treatment of water.

### BACKGROUND ART

There is a need for potable water to contain a safe level of magnesium. The World Health Organization has suggested that magnesium should be present in drinking water. There are many forms of water treatment that remove unwanted components present in water. Ion exchange treatment systems remove calcium and magnesium which can scale pipes and cause damage to fixtures. Reverse osmosis and distillation treatment systems remove virtually all ionic species and can also remove some pathogens. These techniques make the water safer and cleaner, however they also remove the magnesium, a mineral that is beneficial to human health. In addition, many consumers find that water containing some amount of magnesium also tastes better.

There are many patents that deal with re-mineralization of purified water. For example, U.S. Pat. No. 5,443,739 describes an apparatus for a water purification and dispenser with uncontaminated mineral addition. In this case, minerals are added via a pump or eductor. PCT application WO2005/115922 for an “additive dispensing system and water filtration system” claims addition of, for example, minerals, vitamins or others to treated water wherein the consumer can select the components they wish to add. The addition is via an injection pump or eductor as well.

U.S. Pat. No. 5,786,006 describes a method of making mineralized drinking water via addition of aqueous chromium, magnesium, calcium, lithium, and potassium salts where the salts are present in the ionic form. While not explicitly stated, it can be assumed that the metal salts are either injected into the water via pump or eductor or alternately added in a batch process to arrive at a specific concentration in purified water.

U.S. Pat. No. 4,496,443 describes magnesium fortification of feed water for cattle to improve their health. Magnesium is infused into the water by electrolytic dissolution of a magnesium anode. Colloidal magnesium hydroxide predominates wherein the magnesium is in the form of “gelatinous lyophillic colloidal magnesium hydroxide”. The patent does indicate the magnesium may also occur as carbonates or bicarbonates, which would be formed with naturally occurring, dissolved carbon dioxide. However, the patent stipulates that colloidal hydroxide is the preferred species. Since no mention is made of addition of buffering, it can be assumed the pH of the treated water would be highly alkaline. The patent is also silent on the issue of self corrosion of magnesium. This corrosion can be very substantial leading to excessive hydrogen generation and undesirably high levels of magnesium hydroxide.

U.S. Pat. No. 6,544,561 describes a process for preparing an aqueous metal carbonate solution, wherein magnesium carbonate is reacted with an “effective” amount of carbon dioxide in order to be soluble and buffer the solution to between 7.38 and 9. The patent is silent on the method of addition of the carbon dioxide and does not utilize the magnesium carbonate.

U.S. Pat. No. 7,153,438 describes a process and composition for sanitizing drinking water as well as masking the taste and odors commonly found in water. The patent states the need to make contaminated water potable but also notes the desire to mask undesired tastes and odors associated with purification of contaminated water. Magnesium not only has health benefits but is also an effective masking option.

Each of these cited patents have drawbacks. Addition of the mineral salts requires high pressure injection pumps or eductors, solution handling equipment and has the disadvantage of increased cost, complexity, and size or addition of unwanted anions such as chloride. Electrolytic dissolution can provide a simpler system but unless coupled with active carbonation of the feed water the magnesium compound will be primarily the hydroxide, dramatically limiting the amount of soluble magnesium corn pounds present.

### DISCLOSURE OF THE INVENTION

The present invention provides the new and improved water treatment system in which magnesium is added to water that is initially treated by a pretreatment process such as passing water through a reverse osmosis membrane. In the preferred embodiment, the present invention introduces magnesium along with calcium to improve the taste of the water as well as helping to correct low pH and also provide potential health benefits.

The disclosed apparatus and process can re-mineralize treated potable water that has had the hardness components removed. The process is particularly useful as an in-line process for continuous or semi-continuous treatment. This need can be met by dissolving a magnesium compound in the treated water. A reverse osmosis membrane is a common technology to make potable water however the hardness components are removed during this water treatment process. Magnesium is added to the treated water by passing the water over and through a magnesium compound.

In the preferred and illustrated embodiment, the water system includes a reverse osmosis cartridge through which the water to be treated is initially, passed. The water treated by the reverse osmosis membrane is then conveyed to a filter assembly that may include a replaceable cartridge, by which magnesium is added to the treated water. This water with magnesium added may be stored in a vessel and/or delivered to a dispenser or faucet.

In accordance with the invention, the replaceable cartridge of the filter assembly includes a first chamber and a second chamber separated by filter pads and through which the treated water passes. In the preferred embodiment, one of the chambers includes a magnesium compound; the other of the chambers contains a calcium compound. As the water passes through the cartridge, magnesium is added to the water. The calcium compound is used to control or affect pH and to improved taste.

In a more preferred embodiment of the invention, at least some of the water leaving the reverse osmosis membrane bypasses the filter cartridge, i.e., does not pass through the chambers containing the magnesium and/or calcium compounds. This bypassing water, which is mixed with the water discharged by the filter assembly, is used to adjust the mineral concentration of the re-mineralized water delivered to the faucet.

According to a feature of this more preferred embodiment, the structure for bypassing water around the cartridge comprises an orifice that directly communicates an inlet to the cartridge to an outlet of the cartridge. In the illustrated embodiment, the outlet of the cartridge includes a check, valve that inhibits reverse flow at the outlet and also inhibits the migration of dissolved magnesium when water is not flowing through the cartridge.

In the preferred embodiment, the magnesium compound is magnesium phosphate dibasic trihydrate. The calcium compound is used to control or correct pH of the water and also improves taste. In the preferred and illustrated embodiment, the calcium compound is calcium carbonate.

As indicated above, the preferred magnesium compound is magnesium phosphate dibasic trihydrate. However, it is believed that other magnesium compounds can be used. It is also believed that for some of these other magnesium compounds additional treatment or processing steps me be needed to arrive at a desired water quality. Other magnesium compounds that may be used in the disclosed water treatment system include: dolomite, magnesium agricultural lime, magnesium carbonate, magnesium carbonate hydroxide, magnesium phosphates, magnesium silicates, magnesium oxide, magnesium mandelate, magnesium citrate, magnesium chloride, magnesium fluoride, and the like. However the level of magnesium (approximately 10-30 parts per million) along with the pH (within the range of 6 to 11) and the alkalinity levels need to be maintained within the desired ranges. With the preferred compound this is accomplished by using a mitigating calcium compound such as calcium carbonate. The above listed compounds may require other techniques or apparatus to achieve the desired result.

Additional features of the invention will become apparent and a fuller understanding obtained by reading the following detailed discussion made in connection with the accompanying drawings.

### BRIEF DESCRIPTION OF DRAWINGS

FIG. 1 is a schematic representation of a water treatment system constructed in accordance with one preferred embodiment of the invention.

FIG. 2 is a cross section of a cartridge used in the water treatment system constructed in accordance with one preferred embodiment of the invention.

### DESCRIPTION OF SPECIFIC PREFERRED EMBODIMENTS OF THE INVENTION

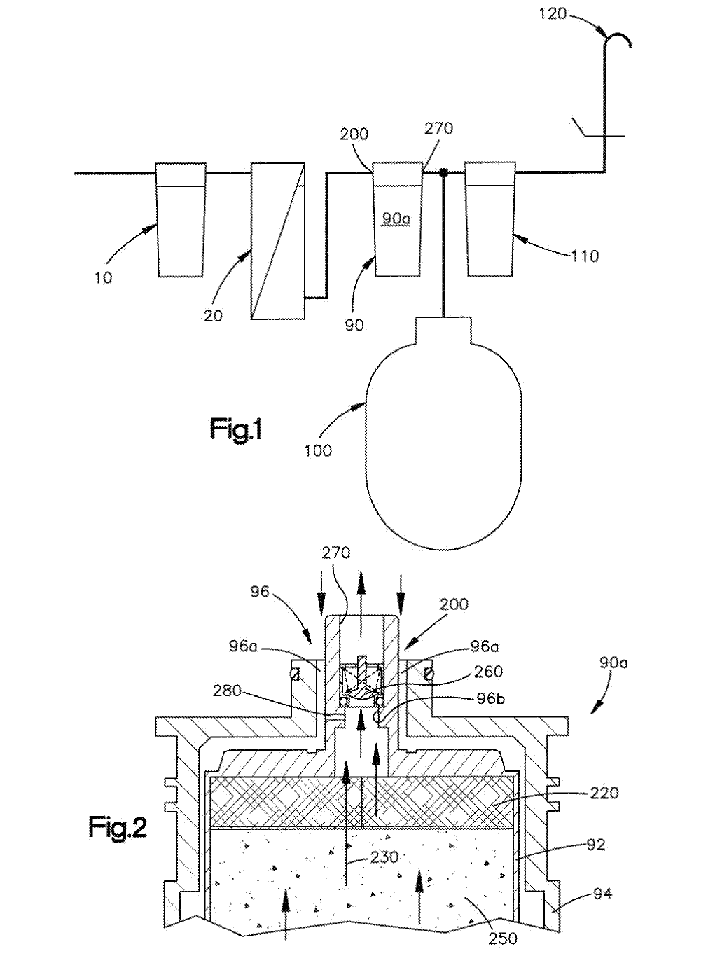

FIG. 1 schematically illustrates a water treatment system for producing water that contains desired minerals for taste as well as human health reasons. In the illustrated embodiment, the water to be treated (or raw water) is first fed through a prefilter 10 to remove sediment and other particulates carried by the water. From the prefilter, the water to be treated is conveyed to a reverse osmosis membrane housed in a vessel 20.

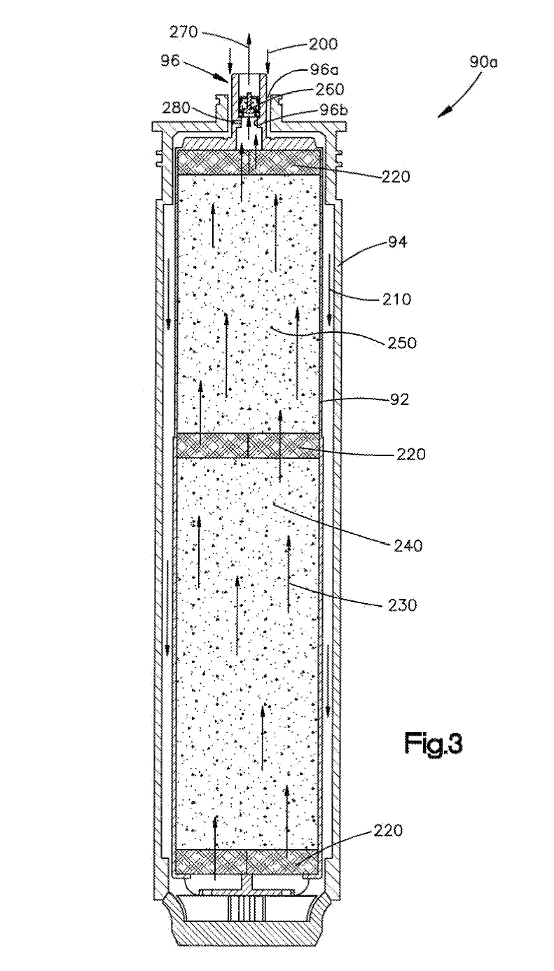

The purified water discharged by the reverse osmosis membrane is then conveyed to a filter assembly 90 which may include a replaceable cartridge 90a (see FIG. 2), and which operates to add a desired mineral, etc. to the purified water. In the preferred and illustrated embodiment the filter assembly 90 adds magnesium to the water. The assembly 90 may also control or affect the pH of the water.

The water containing the desired level of magnesium and also at the desired pH level is stored in a vessel 100 until the water is needed. Due to the materials available, many storage tanks impart an unwanted taste or odor, therefore a postfilter 110 is used. The postfilter 110 is used to remove any volatile organic compounds as well as removing any taste or odor contributed by the storage tank. The dispenser 120k used to dispense water treated by the system.

FIG. 2 shows a cross section of the replaceable cartridge 90a used in the illustrated water treatment system for producing water that contains desired minerals for taste and potentially for human health reasons. In the illustrated embodiment water that has been pretreated by the prefilter 10 and reverse osmosis membrane 20 (both shown in FIG. 1 enters the cartridge 90a through the inlet 200 and at least a portion of it flows between inner and outer walls 92, 94 of the cartridge as shop by the influent water flow path arrows 210. The inner wail 92 defines an inner cartridge that houses the minerals, chemicals, etc. to be added to the water as it flows through the inner cartridge. In the illustrated embodiment, the inner cartridge includes magnesium and calcium compounds. In accordance with the invention, the magnesium and calcium compounds are confined by internal filter pads 220.

In accordance with the invention water flows downwardly along the flow path 210 and then flows through the first of the three internal filter pads 220 that are used to keep the magnesium and calcium compounds separated. The filter pads 220 also remove any particulate that may be in the water.

After flowing through the first of the filter pads 220, the water then flows through a chamber 240 containing the magnesium compound (shown by the process water flow arrows 230) where the desired amount of magnesium is added to or dissolves into the water. The water then flows through the second filter pad 220 and enters a second chamber containing the calcium compound 250. The water leaves the calcium chamber through the final filter pad 220 and travels through a check valve 260 used to prevent the migration of dissolved magnesium during periods of non water flow and usage. The water leaves the filter assembly 90 through the outlet 270 where it goes onto the storage tank 100 (shown in FIG. 1).

It is believed that other magnesium compounds can produce the desired results. Such compounds include: dolomite, magnesium agricultural lime, magnesium carbonate, magnesium carbonate hydroxide, magnesium phosphates, magnesium silicates, magnesium oxide, magnesium mandelate, magnesium citrate, magnesium chlor id fluoride, and the like. However the level of magnesium (approximately 10-30 parts per million) along with the pH (within the range of 6 to 11) and the alkalinity levels need to be maintained within the desired ranges. With the preferred compound this is accomplished by using a mitigating calcium compound such as calcium carbonate.

In accordance with a more preferred embodiment of the invention, a portion of the pretreated water bypasses the magnesium and calcium compounds via bypass orifice 280 located below the check valve 260. (Alternatively, the bypass orifice may be located above the check valve 260). As seen best in FIG. 2, the inlet 200 and outlet 270 constitute concentric passages formed in a neck 96 of the cartridge 90a. As seen in FIG. 2, the bypass orifice 280 communicates an inlet passage 96a with an outlet passage 96b defined by the neck 96. It should be noted here that the inlet passage 96a communicates with the influent water flow path 210 whereas the central passage 96b communicates with the processed water flow path 230.

The purpose of the bypass orifice or passage 280 is to control or adjust the rate of dissolution of the mineral compounds in the cartridge. As indicated above, the cartridge 90a receives permeate from the reverse osmosis cartridge 20. Permeate flow rates are typically low, especially for units of the type shown in FIG. 1 which may, for example, be located in the kitchen where permeate is dispensed a glass at a time. In these types of units, the permeate flow rate could be in the range of 200 nil per minute.

Permeate has a lowered ph which, coupled the paucity of minerals, makes an “aggressive” water, meaning it tends to draw material off surfaces it comes in contact with. The re-mineralization cartridge 90a contains mineral compounds that tend to yield higher concentrations of targeted minerals, i.e., magnesium calcium, when exposed to permeate. A minimum amount of the magnesium compound is required to enable the cartridge to deliver magnesium within an appropriate range of concentrations for the life of the cartridge. As an example, for a system producing 200 ml per minute of permeate, it may be desirable that the re-mineralization cartridge 90a be capable of treating approximately 500 gallons of water. As one would expect, the concentration of the magnesium imparted to the permeate being processed starts out higher when a fresh cartridge is installed and decreases over time as the magnesium in the cartridge is depleted. Excessive concentrations of magnesium are undesirable, but using less magnesium compound in the cartridge is not an option since it will reduce the life of the cartridge.

The use of the bypass passage which allows a portion of the permeate to bypass the cartridge has been found to stabilize the rate of dissolution of the mineral compounds over the life of the cartridge and to control the final concentration of magnesium in the product water over the cartridge's life. For the system shown in FIG. 1 and having a permeate flow rate of approximately 200 ml nil per minute, a bypass orifice or passage 280 having a diameter in the range of 0.040″ has provided satisfactory results. With the disclosed bypass, the final blend of permeate and re-mineralized water has a magnesium concentration within the targeted range over the life of the cartridge.

Although the invention has been described with a certain degree of particularity, it should be understood that those skilled in the art can make various changes to it without departing from the spirit or scope of the invention as hereinafter claimed.

1. A water treatment system comprising:
a. a reverse osmosis filter;
b. a manifold for delivering water to be treated to said reverse osmosis filter;
c. a replaceable cartridge containing a granular or solid magnesium compound;
d. a storage tank to accumulate at least partially treated water;
e. a dispenser for dispensing treated water from said treatment system;
f. a second filter that is in fluid communication with said storage tank and having an outlet in fluid communication with a said dispenser.

2. The water treatment system of claim 1 wherein said magnesium compound is obtained from a member of the group comprising magnesium agricultural lime, magnesium carbonate, magnesium carbonate hydroxide, magnesium phosphates, magnesium silicates, magnesium oxide, magnesium mandelate, magnesium citrate, magnesium chloride, magnesium fluoride, and the like.

3. The water treatment system of claim 1. wherein the resulting concentration of magnesium is controlled by including a calcium compound in said replaceable cartridge.

4. The water treatment system of claim 1 wherein the resulting pH level is controlled by including a calcium compound in said replaceable cartridge.

5. The water treatment system of claim 1. wherein the resulting concentration of magnesium pH level, and/or alkalinity level is controlled by including a calcium compound in said replaceable cartridge.

6. The water treatment system of claim 3 wherein said calcium compound is calcium carbonate.

7. The water treatment system of claim 1 wherein said level of magnesium is in the range of about 10 to 30 parts per million.

8. The water treatment system of claim 1. wherein said water has pH in the range of about 6 to M.

9. The water treatment system of claim 1, wherein at least one unidirectional check valve is used to limit the transport or migration of dissolved magnesium in the upstream or downstream direction during periods when water is not flowing through the water treatment system.

10. The water treatment of claim 1 wherein the magnesium compound is magnesium phosphate dibasic trihydrate.

11. The water treatment system of claim 1 further comprising structure defining a water bypass for allowing a quantity of water leaving said reverse osmosis filter to bypass said replaceable cartridge in order to adjust the magnesium concentration of water discharged by said dispenser.

12. The apparatus of claim 11, wherein said bypass structure comprises an orifice for directly communicating an inlet of said replaceable cartridge with an outlet of said replaceable cartridge.
